(19) United States
(12) Patent Application Publication
(10) Pub. No.: US 2017/0222886 A1
(43) Pub. Date: Aug. 3, 2017

(54) METERING STORAGE USAGE

(71) Applicant: HEWLETT PACKARD ENTERPRISE DEVELOPMENT LP, Houston, TX (US)

(72) Inventors: Vijay Ram S, Bangalore (IN); Vikram Krishnamurthy, Bangalore (IN)

(21) Appl. No.: 15/407,483

(22) Filed: Jan. 17, 2017

(30) Foreign Application Priority Data
Jan. 28, 2016 (IN) 201641003027

(51) Int. Cl. H04L 12/24; H04L 29/08

(52) U.S. Cl. CPC H04L 41/5032; H04L 67/1097

(57) ABSTRACT

In one example, at least one storage usage category for a storage volume identified for metering is determined. The at least one storage usage category may indicate how the storage volume operates to store data over a networked computing environment. Once the at least one storage usage category is determined, a usage value for the storage volume of the at least one storage usage category is obtained, wherein the usage value provides a measure of usage of the storage volume.

### BACKGROUND

Networked computing environments may provide storage which may be used for supporting other computing entities. Such environments may include a plurality of storage devices which may be presented as logical and discrete units of storage. Furthermore, the storage being provided may be prescribed and allocated to users or subscribers. Accordingly, the storage usage may be tracked to measure the volume of storage which has been availed by the user.

### BRIEF DESCRIPTION OF THE DRAWINGS

The following detailed description references the drawings, wherein:

FIG. 1 is a block diagram of an example system for metering storage usage;

FIG. 2 is an illustration of a computing environment implementing a system for metering storage usage, according to an example of the present subject matter;

FIG. 3 is another block diagram of an example system for metering storage usage;

FIG. 4 is a flowchart of an example method for metering storage usage;

FIG. 5 is a flowchart of another example method for metering storage usage; and

FIG. 6 is a block diagram of an example system implementing a non-transitory computer-readable medium, for metering storage usage.

### DETAILED DESCRIPTION

Data generated as a result of business operations has increased many folds over the past years. As a result, users within organizations continuously seek to increase efficiency associated with data storage. This has also resulted in data storage being provided as a service. Organizations may subscribe to specific amounts of storage space based on their operations. The storage space may be specifically provisioned depending on the extent to which the storage space is being used. Since specific amounts of storage space is allocated to different organizations, the usage of storage space has to be tracked to determine the volume of data storage that has been utilized. Consequently, the organizations may be appropriately billed based on the volume of storage space that has been utilized.

In order to determine the volume of storage used, the storage space may be metered. Metering may be considered as periodically determining the extent of storage usage of a storage volume. Service providers providing storage space as a service seek to accurately meter the storage usage, so that the storage space that has been used is accurately estimated, and at the same time provide an estimate of the space that is yet available for use. Such an estimate may in turn allow subscribers to determine if any additional storage is to be further subscribed to in order to ensure continuity in services. Correct estimates of storage usage may also avoid any erroneous billing that may follow in response to such storage based services which are provided.

Approaches for metering storage usage within a network computing environment are described. The network computing environment may be considered as any networked computing environment involving a plurality of computing entities in communication with a networked storage. The computing entities may include any processor based computing systems which in turn may communicate with the networked storage through a communication network. Examples of computing entities include, but are not limited to, servers. Such servers may exist as either standalone devices or may be deployed as a cluster of servers. The networked storage may be implemented using storage arrays. Each of such storage arrays may be composed of storage volumes which are utilized for storage. The storage volumes may further be abstracted logically, for example, in the form of a Logical Unit Number (LUN).

In some examples, for a storage array within a networked storage, a list of storage volumes to be metered may be determined. The list of the storage volumes may be based on information which may be generated by a storage resource management platform. Such information, besides including a list of storage volumes present within the networked computing environment, may also include configuration settings pertaining to the networked storage. Such configuration settings may enable the computing entities to communicate with, and store data on the networked storage.

For the listed storage volumes, a storage usage category may be determined. In one example, the storage usage category may be considered as indicative of category or a manner in which a storage volume of the listed storage volumes, is used or operates. The storage volume may operate or may be used for a variety of functions, such as for implementing a thin provisioning or thick provisioning computing environment, as a shared volume between multiple hosts, volumes being actively used for writing data, and for storing replication data. The different categories described above under which the storage volume is used, are few examples, and other categories may also be present without deviating from the scope of the present subject matter.

On determining the storage usage category for the storage volume, a corresponding usage value of the storage volume of the storage usage category may be determined. The usage value may provide a measure of the storage volume used, when the storage volume is implemented as one of the storage usage categories. For example, the usage value in cases where the storage volume is used as a shared volume may indicate the amount of storage volume being shared between different hosts.

In such a manner, the actual storage usage for the storage volume may be accurately estimated. Since the determination of storage usage may correspond to the storage usage category rather than the space allocated, the estimate of the storage usage may accurately reflect the actual storage used, when the storage volume operates as one of the storage usage categories. An accurate estimate of the usage of the storage volume may, for example, result in better estimates for provisioning, in case additional storage space is to be further availed. Consequently, subscribers may be informed in advance of the amount of storage space left thereby assisting continued service and any billing efforts for charging the usage of the storage volume.

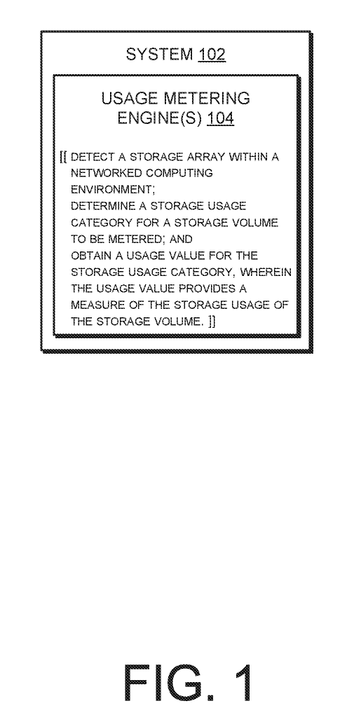

These and other aspects are described in conjunction with a computing based device and its operations, as shown in FIGS. 1-6. FIG. 1 illustrates an example metering system 102 for metering storage usage within a storage volume. In the present example, the metering system 102 (hereinafter referred to as system 102) includes usage metering engine(s) 104. The system 102 may be implemented as a standalone device coupled to a storage array within a networked computing environment. The computing environment may include computing entities and the storage array. The storage array, in turn, may include a plurality of storage volumes providing the storage space utilized by computing entities within the networked computing environment. In another example, the system 102 may be implemented as a device incorporating the storage array, with the system 102 to communicate with, and manage and control the operations of the storage array. The present description is provided considering that the system 102 is communicatively coupled to the storage array (not shown in FIG. 1). However, other possible example implementations, as noted above, may also be used without deviating from the scope of the present subject matter.

In operation, the usage metering engine(s) 104 may receive attributes of the networked computing environment. The attributes, amongst other aspects, include information pertaining to various members of the networked computing environment along with information pertaining to storage volumes which may be present. The usage metering engine(s) 104, based on the attributes of the networked computing environment, may determine the storage volumes which may be present (e.g., all of the storage volumes) within the networked computing environment. Of the storage volumes which are present within the networked computing environment, a storage volume may be identified for metering. As noted above, metering the storage volumes may include estimating the volume of space in any of storage volume used by a user or subscriber. Such estimates, in some instances, may be carried out periodically to determine the extent of storage usage of any of the storage volumes. The usage of the storage volume, in turn, may be based on the manner in which the storage volume may be used.

For the storage volume which is identified for metering, a storage usage category is further determined by the usage metering engine(s) 104. In one example, the storage usage category for the storage volume may also be determined based on the attributes of the networked computing environment. A storage volume may be used in various ways. Each of such ways, may in turn utilize the space available within the storage volume in different measures. The storage usage category may be considered as indicative of the manner or a category as which any storage volume is utilized, when it operates in the storage usage category. Examples of storage usage category include, but are not limited to, whether the storage volume includes actual allocated blocks, whether the storage volume is being used as a shared volume, or whether it is being actively used for data read-write operations or for storing replication data. In one example, the storage volume may be used as a different storage usage category at different instances.

Once the storage usage category is determined for the storage volume under consideration, the usage metering engine(s) 104 may further determine a usage value corresponding to the storage usage category for the storage volume. The usage value may indicate the measure of the storage that has been used in the storage volume of the storage usage category. In one example, the usage value may be provided as a percentage value of the total size of the storage volume. In another example, the usage value may be indicated in terms of megabytes (MB) of space allocated or in terms of amount of space being shared between different hosts. In another example, the usage value may indicate the number of input-output (I/O) operations or I/O operations per second (IOPS) which are registered on the storage volume.

The usage metering engine(s) 104 uses the amount of space used, as represented by the usage value, for metering the storage volume. Such metering may be implemented at periodic intervals to determine the extent of usage of storage space within the storage volume. Once the space utilized within the storage volume is evaluated, as represented by the usage value, the storage space utilized may be considered for provisioning if more storage space is desired. In another example, the amount of space utilized in the storage volume may be communicated to the subscriber. The metering approaches as described may be used periodically, or may be used for determining the usage value in real-time. In one example, based on the amount of space utilized for the storage volume, a predetermined action, such as generation of alerts, may also be performed.

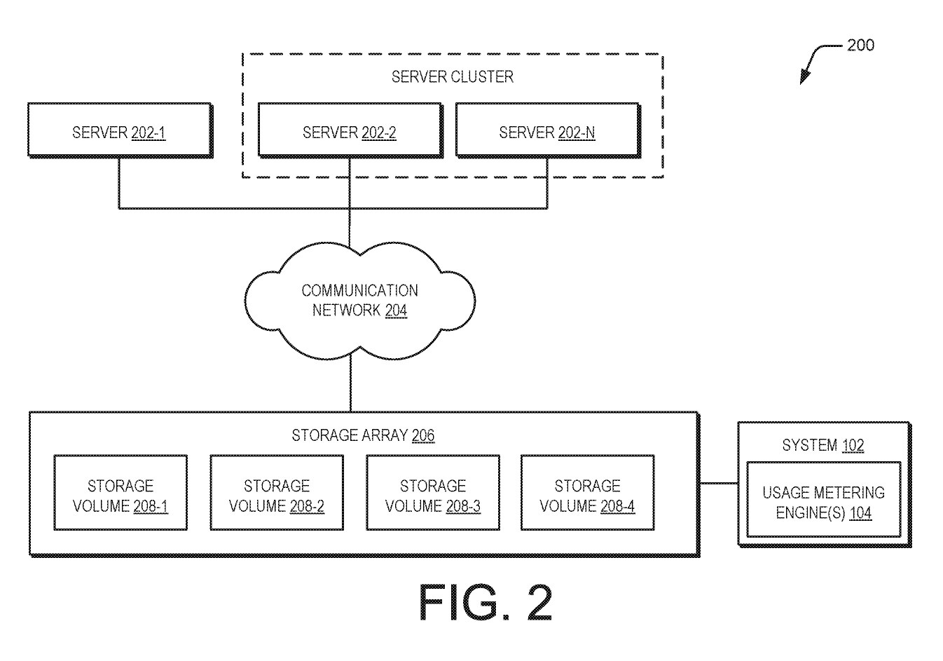

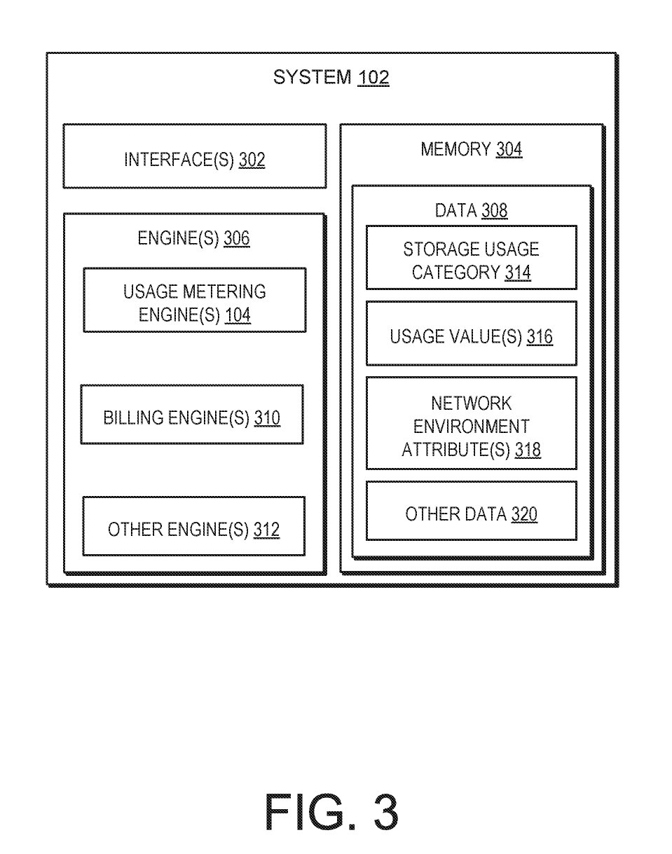

These and other functionalities are provided in further detail in conjunction with FIGS. 2-3. FIG. 2 illustrates an example networked computing environment 200 having a plurality of computing entities and a networked storage. The computing entities may be implemented as servers 202-1, 2, . . . , n. Any one of the servers 202-1, 2, . . . , n (collectively referred to as servers 202) may be implemented as either a standalone device, e.g., server 202-1, or as a cluster of servers (incorporating servers 202-2, . . . , n). The servers 202 may process requests from various users or applications executing on the servers 202 themselves. Based on the processing of such requests, the servers 202 may communicate over the network 204, with the storage array 206. Based on the requests, data is either read from, or written to, the storage array 206. The network 204 may include, for example, a local area network (LAN), a wireless local area network (WLAN), a virtual private network (VPN), the Internet, or the like, or a combination thereof. In some examples, a computer network may include a telephone network (for example, a cellular telephone network).

The storage array 206 is coupled to the system 102. The system 102 in turn includes the usage metering engine(s) 104 for metering storage usage of a storage volume within the storage array 206. Continuing with the present example, the storage array 206 further includes storage volumes 208-1,2,3, and 4. For metering storage usage of any of the storage volumes 208-1,2,3 and 4 (collectively referred to as the storage volumes 208), the usage metering engine(s) 104 may initially determine a storage usage category for each of the storage volumes 208. Once determined, the usage metering engine(s) 104 obtains usage value corresponding to the storage usage category for each of the storage volumes 208. The usage value indicates the amount of storage usage of any of the storage volumes 208 while it operates as one of the storage usage category. The usage value may be provided either in terms of bytes of data (e.g., megabytes or MBs) or in terms of percentage of the total storage available with the storage volumes 208.

The manner in which the storage usage for a storage volume is determined, and other aspects thereof, is further described in detail in conjunction with FIG. 3. FIG. 3 illustrates an example system 102 for metering storage usage within a storage volume. The system 102 may be implemented as a standalone computing system communicatively connected through a network to other devices. The system 102 includes interface(s) 302 and memory 304. The interface(s) 302 may include a variety of interfaces, for example, interfaces for data input and output devices, referred to as I/O devices, storage devices, network devices, and the like. The interface(s) 302 facilitate communication between the system 102 and various computing devices connected in a networked environment. In one example, the interface(s) 302 may provide an interface for communication between the system 102 and the storage array 206.

The memory 304 may store computer-readable instructions, which may be fetched and executed to meter storage usage of storage volume. The memory 304 may include any non-transitory computer-readable medium including, for example, volatile memory such as RAM, or non-volatile memory such as EPROM, flash memory, and the like. The system 102 further includes engine(s) 306 and the memory 304 includes data 308.

The engine(s) 306 may be implemented as a combination of hardware and programming (for example, programmable instructions) to implement specific functionalities of the engine(s) 306. In examples described herein, such combinations of hardware and programming may be implemented in a number of different ways. For example, the programming for the engine(s) 306 may be processor executable instructions stored on a non-transitory machine-readable storage medium and the hardware for the engine(s) 306 may include a processing resource (for example, a processor), to execute such instructions. In the present examples, the machine-readable storage medium may store instructions that, when executed by the processing resource, implement engine(s) 306. In such examples, the system 102 may include the machine-readable storage medium storing the instructions and the processing resource to execute the instructions, or the machine-readable storage medium may be separate but accessible to system 102 and the processing resource. In other examples, engine(s) 306 may be implemented by electronic circuitry.

The data 308 includes data that is either stored or generated as a result of the functionalities implemented by any of the engine(s) 306. In an example, the engine(s) 306 include the usage metering engine(s) 104, billing engine(s) 310 and other engine(s) 312. The other engine(s) 312 may implement functionalities that supplement applications or functions performed by the system 102 or engine(s) 306. Further, the data 308 may include storage usage category 314, usage value(s) 316, network environment attribute(s) 318, and other data 320.

For metering storage usage within a storage volume, the system 102 may initially obtain information pertaining to the environment 200 to identify the storage volumes which are to be metered. In one example, such information is stored as network environment attribute(s) 318. The network environment attribute(s) 318 may include any information pertaining to member entities of the networked computing environment 200. For example, the network environment attribute(s) 318 may specify, amongst other things, the number of computing entities, such as servers 202 and a storage array 206 which are present in the environment 200. The network environment attribute(s) 318 may also indicate connection information associating the servers 202 and the storage array 206. Such connection information may be in the form of a mapping linking ports of servers 202 and the ports of any of the volumes 208 of the storage array 206.

Once obtained, the usage metering engine(s) 104 may determine the storage volumes (e.g., all of the storage volumes) which may be present within the networked computing environment 200. Of the storage volumes present within the networked computing environment 200, the usage metering engine(s) 104 may identify the storage volumes, such as storage volumes 208 to be metered. Metering may involve periodically determining the amount of storage which has been used within any one of the storage volumes 208. In one example, the usage metering engine(s) 104 may identify the storage volumes 208 to be metered based on specific rules or based on an input from a user, such as an administrator associated with the storage space service provide. Although FIG. 2 depicts storage volumes 208-1,2,3 and 4, the storage array 206 may include additional storage volumes 208 without deviating from the scope of the present subject matter.

With the storage volumes 208 identified for metering, the usage metering engine(s) 104 further determines a storage usage category, based on attribute(s) 318. As also explained previously, the storage volumes 208 may be used in different ways for storing data. For example, one of the storage volumes 208, say storage volume 208-1 may be used in a manner such that it implements actual blocks which have been allocated for storage. In another case, the storage volume 208-2 may be implemented as storage volumes which are shared between two or more entities, such as servers 202. Once the storage volume 208-1 and storage volume 208-2 have been identified for metering, the usage metering engine(s) 104 determines the storage usage category 314 as actual allocated blocks and shared storage volume, respectively. With the storage usage category 314 identified for the storage volumes 208-1 and 2, the usage metering engine(s) 104 further determines the amount of storage used by the storage volumes 208, which is stored as usage value(s) 316. In one example, the storage usage category 314 for the respective storage volumes 208 is obtained from the attribute(s) 318, as explained in the following paragraphs. The usage metering engine(s) 104 may individually assess the storage usage category 314 for each of the storage volumes 208, i.e., the storage volumes 208-1,2,3 and 4. Once determined, the storage usage may be determined based on the corresponding usage value(s) 316 of the respective storage volumes 208.

In some cases one of the storage volumes 208, e.g., the storage volume 208-1, may include physical storage blocks which are actually allocated to a computing entity. The computing entity may be a virtual machine within a thin provisioning or a thick provisioning environment. In thin provisioned environments, the actual number of blocks which are available for writing data, at any instant, are less than the total storage space that may have been allocated to a computing entity. In case of thick provisioned environments, the actual number of storage blocks being used for writing data would be equal to the storage space allocated to the computing entity.

In either case, the usage metering engine(s) 104 determines whether one of the storage volumes 208, e.g., storage volume 208-1 are actual blocks allocated for writing data. In the example, the determination of the storage volume 208-1 as actual blocks allocated for data writing, is based on the attribute(s) 318 of the networked computing environment 200 which indicates the total number of physical storage blocks which may be allocated to a computing entity. Once the storage usage category 314 is determined for storage volume 208-1 the actual number of physical blocks that are allocated within the networked computing environment are determined, and stored as usage value(s) 316.

Within the storage array 206, the usage metering engine(s) 104 may proceed to the next storage volume, i.e., storage volume 208-2. The usage metering engine(s) 104, on processing the attribute(s) 318 may determine that the port address of the storage volume 208-2 is mapped with port addresses of multiple hosts or computing entities within the networked computing environment 200. For example, the port address of storage volume 208-2 may be mapped to the port addresses of servers 202-1 and 2. Based on the mapping of multiple hosts with one storage volume, e.g., the storage volume 208-2, it would be concluded that the storage volume 208-2 is a shared volume. Once the storage volume 208-2 is determined as a shared volume, the usage metering engine(s) 104 may determine the actual storage space which has been utilized on the storage volume 208-2 itself rather factoring the storage space allocated to servers 202-1 and 2. If the storage space allocated to servers 202-1 and 2 is considered, it may result in the same storage space being counted twice resulting in an inaccurate metering of the space used. This in turn would result in imprecise provisioning and allocation, at a later stage. The storage space utilized for storage volume 208-2 is also stored in usage value(s) 316.

Proceeding to the other storage volumes 208, the usage metering engine(s) 104 may process data in attribute(s) 318 corresponding to the storage volume 208-3. With storage volume 208-3, the usage metering engine(s) 104 may determine the extent of storage space within the storage volume 208-3 as being actively used or not. As would be noted, storage volumes may follow a consume-and-hold utilization pattern. Data blocks within storage volumes, such as the storage volume 208-3, once being written may not be returned to. An example of such a storage volume would include an email archive. Previously received may be retained and saved on the storage volume; however, such mails be seldom accessed again. As a result, within the storage volume 208-3 there may exist a proportion of data blocks which are not accessed once data is written onto them, and the other proportion of data blocks which are routinely accessed. It is also understood, the proportion of data blocks which are actively utilized remain within a discernable margins of utilization. For example, about 10 MB of data may be actively used on a routine basis. On the other hand, the proportion of data blocks which are accessed once for writing data but not accessed subsequently may increase over a period of time. Since such storage space is not used, it may be purged in order for the storage space to be made available for other purposes.

The usage metering engine(s) 104 may monitor the storage volume 208-3 to determine whether the storage volume 208-3 is actively being used or not. In one example, the usage metering engine(s) 104 may determine the input-output requests that may be directed to the storage volume 208-3. In another example, the usage metering engine(s) 104 may monitor the input-output operations per second (IOPS) recorded for the storage volume 208-3. If the I/O requests and the IOPS value are nil, the usage metering engine(s) 104 concludes that the storage volume 208-3 under consideration is not being used. If so, then the storage space used the storage volume 208-3 may be considered for metering.

In one example, the value of the I/O request and the IOPS may be stored as usage value(s) 316. If the usage value(s) 316 for the I/O request and the IOPS is not nil, then the usage metering engine(s) 104 concludes that the storage volume 208-3 is being actively used. In the present example, the storage space being actively used, e.g., the space registering the I/O request and the IOPS is determined and stored in usage value(s) 316 for metering purposes.

For storage volume 208-4, the usage metering engine(s) 104 on processing the attribute(s) 318 may determine that the storage volume is being used for replication data. The replication data may not be created directly by servers, e.g., server 202-1, of the storage space subscribers. In such cases, the storage space utilized for replication data, i.e., backed up data of the original data, may not be considered for determining the extent of storage space which may have been utilized. In the present example, the usage metering engine(s) 104 may then determine the volume of backup data present on backup storage 214. The amount of storage space used, e.g., within the backup storage 214, may be stored as usage value(s) 316. Although the present explanation provides specific examples of storage usage category 314, any other category for other storage volumes 208 may also be utilized for estimating storage usage without deviating from the scope of the present subject matter.

The usage metering engine(s) 104 may obtain the storage usage of the respective storage volumes 208 from the usage value(s) 316. Based on the usage value(s) 316 pertaining to the different storage volumes 208, the usage metering engine(s) 104 utilizes the usage value(s) 316 to estimate the extent of storage space that may be still available for subscribers associated with their respective storage volumes 208. Accordingly, additional storage may be provisioned for the subscribers in a timely manner. In another example, the usage metering engine(s) 104 utilizes the storage usage as estimated through usage value(s) 316, to send communication or a notification based on the usage. For example, the usage metering engine(s) 104 generates and transmits a notification if less than 20% of the storage space as allocated to subscriber is left available.

In one example, once the storage usage has been estimated by the usage metering engine(s) 104, the billing engine(s) 310 may be used to determine the rate at which the subscriber may be billed. In such a case, the billing engine(s) 310 may obtain the billing rates, which in turn may be stored in other data 322. Based on the billing rate, the amount for which the storage usage is to be billed may be evaluated. In addition, the billing engine(s) 310 may also utilize a metering factor stored in other data 320 for billing based on the storage usage category 314. For example, IOPS reads/writes may be registered on the storage volumes having high access speeds and therefore may be billed at a higher rate, as compared to data which is utilized for backup storage. In the approaches as described above, it would be understood that evaluating storage usage based on storage usage category 314 rather than allocation provides a more accurate mechanism. Based on the estimated storage usage, the subscribers may be informed accurately of the usage.

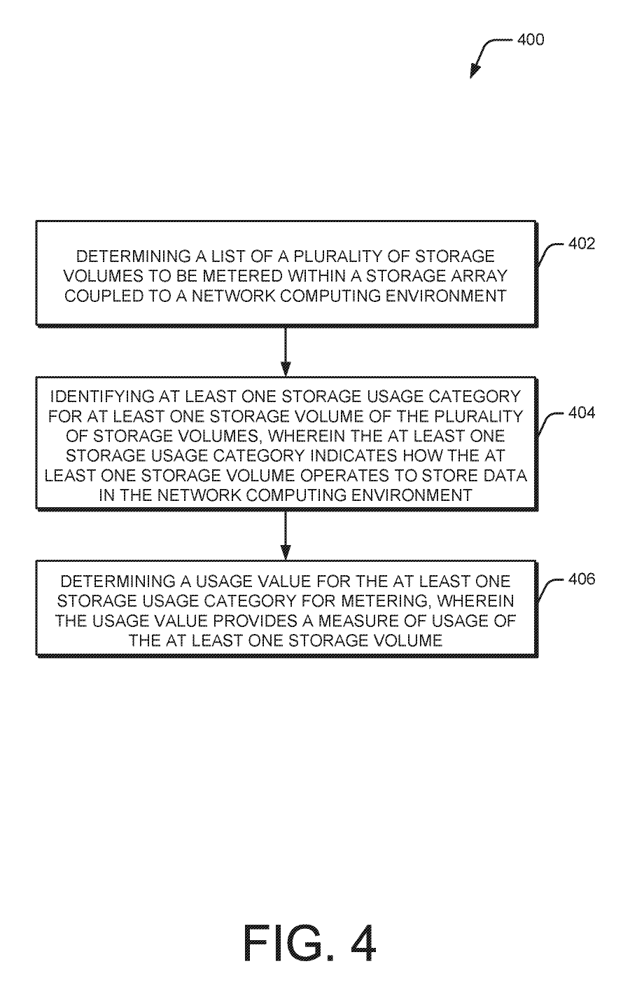

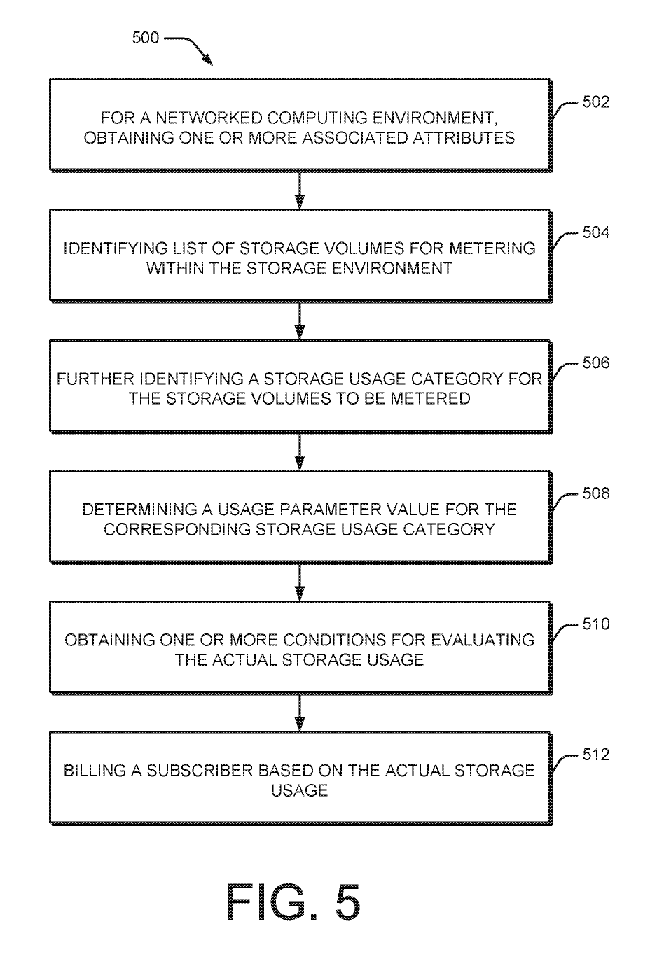

FIGS. 4-5 illustrate example methods 400 and 500, respectively, for metering storage usage within a storage volume, according to an implementation of the present subject matter. The order in which the methods are described is not intended to be construed as a limitation, and any number of the described method blocks may be combined in any order to implement the aforementioned methods, or another method. Furthermore, methods 400 and 500 may be implemented by processing resource or computing device(s) through any suitable hardware, non-transitory machine readable instructions, or combination thereof.

It may also be understood that methods 400 and 500 may be performed by programmed computing devices, such as system 102 as depicted in FIGS. 1-3. Furthermore, the methods 400 and 500 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media. The methods 400 and 500 are described below with reference to system 102 as described above; other suitable systems for the execution of these methods may also be utilized. Additionally, implementation of these methods is not limited to such examples.

Returning to FIG. 4, at block 402 a list of storage volumes to be metered within a storage array is determined. The storage array may be coupled to a computing entity in a networked computing environment. For example, the usage metering engine(s) 104 identifies storage volumes 208 for metering. The identification of the storage volumes 208 as the storage volumes for being metered is based on attributes of a networked computing environment 200. The attributes, amongst other aspects, may provide information pertaining to various storage volumes, such as the storage volumes 208, which may be present within the networked computing environment 200. The usage metering engine(s) 104 initially may identify storage volumes (e.g., all storage volumes) which may be present within the networked computing environment 200, out of which storage volumes 208 may be identified for metering. In one example, the attributes may be stored as attribute(s) 318.

At block 404, at least one storage usage category for a storage volume is identified. The storage usage category may be considered as indicating a manner in which the storage volume stores data. In one example, the storage usage category may be indicated and stored within the system 102 as storage usage category 314. For example, the usage metering engine(s) 104 may storage usage category 314. The storage usage category 314 may also be determined based the attribute(s) 318. Examples of storage usage category include, but are not limited to, whether the storage volume includes actual allocated blocks, whether the storage volume is being used as a shared volume between multiple hosts, or whether it is being actively used for data read-write operations or for storing replication data.

At block 406, a usage value for the storage usage category is determined. The usage value may be considered as a measure of usage of the storage volume, when the storage volume operates as one of the storage usage category. In one example, the usage metering engine(s) 104 may further determine the usage value(s) 316 for each of the storage volumes 208. Based on the usage value(s) 316 determined for the respective storage volumes 208, the amount of storage space used, is estimated. In one example, the usage value(s) 316 may also be used for billing or for provisioning for additional resources, if requested by a subscriber.

FIG. 5 provides another example method for metering storage usage within a storage volume. At block 502, associated attributes of a networked computing environment are obtained. The networked computing environment may include a plurality of computing entities in communication with a storage array. The storage array in turn may include a plurality of storage volumes 208. For example, the usage metering engine(s) 104 may obtain network environment attribute(s) 318 of the environment 200, having a plurality of computing entities and a networked storage.

The attribute(s) 318 in turn provide information pertaining to the networked computing environment 200 such as member computing entities, and mapping between such computing entities. The computing entities may be implemented as servers 202-1, 2, . . . , n. Any one of the servers 202-1, 2, . . . , n (collectively referred to as servers 202) may be implemented as either a standalone device, e.g., server 202-1, or as a cluster of servers (incorporating servers 202-2, . . . , n). Within the networked computing environment 200, the servers 202 are in communicated with the storage array 206.

At block 504, list of storage volumes for metering within the networked computing environment are identified. In one example, the usage metering engine(s) 104 may identify storage volumes (e.g., all storage volumes) which are members within the networked computing environment 200. Of the storage volumes identified, the usage metering engine(s) 104 further identifies storage volumes 208 for metering. In the present example, the usage metering engine(s) 104 identifies the storage volumes 208 for metering be based on specific rules or based on input provided by a service provider.

At block 506, for the storage volumes to be metered, a storage usage category is further determined. The storage usage category indicates the manner in which the storage volumes are operating. In one example, with the storage volumes 208 identified for metering, the usage metering engine(s) 104 further determines a storage usage category 314, based on attribute(s) 318. For instance, the storage volume 208-1 may be used in a manner such that it includes actual blocks which have been allocated for storage. In another case, the storage volume 208-2 may be such that it is shared between servers 208-1 and 2. The usage metering engine(s) 104 determines the storage usage category 314 as implementing actual allocated blocks and shared storage volume, respectively.

At block 508, a usage value for the corresponding storage usage category is determined. In one example, the usage metering engine(s) 104 may further determine the usage value(s) 316 of the various volumes 208, for the corresponding storage usage category 314. With the storage usage category 314 identified for the storage array 206, the usage metering engine(s) 104 further determines the amount of storage used by the storage volumes 208, which is stored as usage value(s) 316. In one example, the storage usage category 314 for the respective storage volumes 208 is obtained from the attribute(s) 318. For instance, for the storage volume 208-1 the usage metering engine(s) 104 may determine the volume of physical storage blocks which have been allocated, say for thin or thick provisioning. In another way, the volume of storage space within the storage volume 208-2 shared between multiple hosts, may be determined. Accordingly, the storage usages for storage volume 208-3 and storage volume 208-4 are also determined, for example, as per approaches described in conjunction with FIG. 3. The usage value(s) 316 may be indicated in terms of the megabytes (MB) of space allocated (i.e., for storage volume 208-1) or in terms of storage space being shared by different hosts (i.e., for storage volume 208-2). In another example, the usage value(s) 316 may indicate the number of input-output (I/O) operations or I/O operations per second (IOPS) (i.e., for storage volume 208-3).

At block 510, conditions for evaluating the actual storage usage are obtained. For example, the usage metering engine(s) 104 may determine whether any conditions or rules are specified for evaluating the storage usage of any of the storage volumes 208. As noted previously, the amount of storage used within the storage volume may vary depending on the storage usage category 314 under which the storage volume may fall within. The rules may prescribe that a metering factor stored in other data 320 for determining the storage usage of any of the volumes 208. For example, IOPS reads/writes may be registered on the storage volumes having high access speeds and therefore may be billed at a higher rate, as compared to data which is utilized for backup storage. In another example, a notification may be generated and transmitted to the subscriber on detecting if less than 20% of the storage space as allocated to subscriber is left available.

At block 512, a subscriber may be billed based on the storage usage. For example, the billing engine(s) 310 may obtain the actual storage usage as indicated by the usage value(s) 316, and any rules or conditions to determine the amount which is to be billed to the subscriber. The storage usage and the corresponding billing performed is more accurate and better represented by the storage usage category 314 rather than the allocation of the storage space when considered alone.

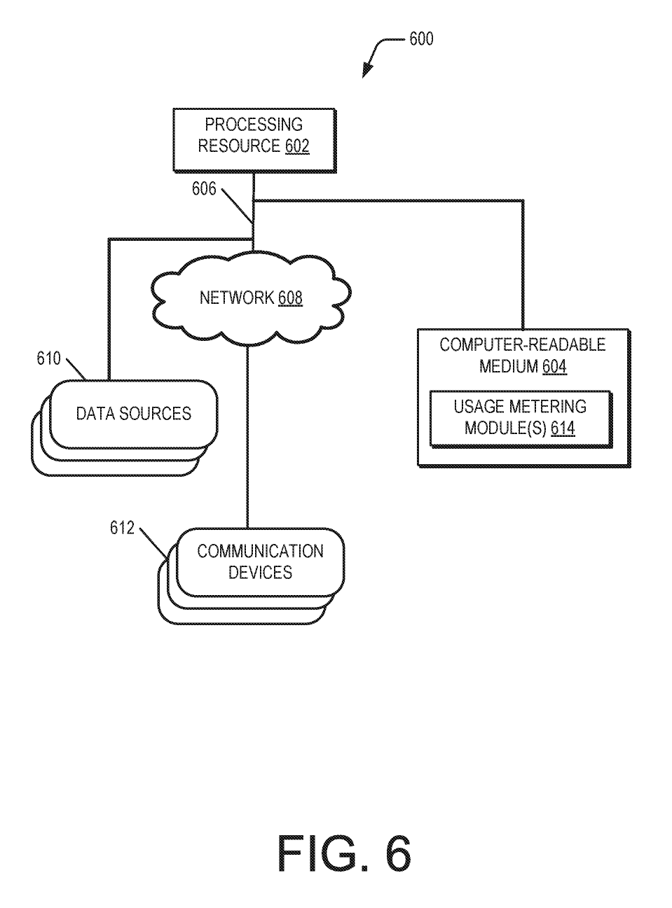

FIG. 6 illustrates a system environment 600 for metering storage usage within a storage volume, according to an example of the present disclosure. The system environment 600 may comprise at least a portion of a public networking environment or a private networking environment, or a combination thereof. In one implementation, the system environment 600 includes a processing resource 602 communicatively coupled to a computer readable medium 604 through a communication link 606.

For example, the processing resource 602 can include a processor of a computing device for metering storage usage within a storage volume. In another example, multiple processors may also be used for implementing the processing resource 602. The computer readable medium 604 may be, for example, an internal memory device of the computing device or an external memory device. In one implementation, the communication link 606 may be a direct communication link, such as any memory read/write interface. In another implementation, the communication link 606 may be an indirect communication link, such as a network interface. In such a case, the processing resource 602 can access the computer readable medium 604 through a network 608. The network 608 may be a single network or a combination of multiple networks and may use a variety of different communication protocols.

The processing resource 602 and the computer readable medium 604 may also be coupled to data sources 610 through the communication link 606, and/or to communication devices 612 over the network 608. The coupling with the data sources 610 enables in receiving the data in an offline environment, and the coupling with the communication devices 612 enables in receiving the data in an online environment.

In one implementation, the computer readable medium 604 includes a set of computer readable instructions, implementing a usage metering module(s) 614. The instructions implementing usage metering module(s) 614 may, in one example, be executable code for metering storage usage within a storage volume. The set of computer readable instructions within medium 604 may be accessed by the processing resource 602 through the communication link 606 and subsequently executed to process data communicated with the data sources 610 in order for metering storage usage within a storage volume.

In one example, the usage metering module(s) 614 may receive information pertaining to attributes of a networked computing environment. The attributes, may also specify provide information pertaining to various storage volumes which may be present within the networked computing environment. In one example, the attributes may be stored as network environment attribute(s) 318 (referred to as attribute(s) 318). The usage metering module(s) 614, based on the attribute(s) 318 of the networked computing environment 200, may determine its member storage volumes may be present. Of the storage volumes which are present within the networked computing environment, the storage volumes 208-1,2,3 and 4 (collectively referred to as storage volumes 208) are identified for metering.

For the storage volumes 208, the usage metering module(s) 614 determines the storage usage category 314. In one example, the storage usage category 314 for any storage volume may be determined based on the attribute(s) 318 of the networked computing environment 200. Examples of storage usage category 314 include, but are not limited to, whether the storage volume implement actual blocks allocated within the storage volume, whether the storage volume is shared between multiple hosts, or whether being actively used for data read-write operations or for replication data. The storage volume may be used as per different storage usage category 314. In case the storage volume is being used for more than one storage usage category 314 as specified, the usage metering module(s) 614 may determine the appropriate storage usage category 314 based on the attribute(s) 318 of the networked computing environment 200.

Once the storage usage category 314 is determined for the storage volume under consideration, the usage metering module(s) 614 may further determine the usage value(s) 316 corresponding to the storage usage category 314. In one example, the usage value(s) 316 may be indicated in terms of the kilobytes (KB) of space allocated. In another example, the usage value(s) 316 may indicate the number of input-output (I/O) operations or I/O operations per second (IOPS). On determining the usage value(s) 316, the usage metering module(s) 614 may determine the actual usage of the storage volume based either directly on the usage value(s) 316 or may be proportional to the usage value(s) 316. Once the space utilized within the storage volume, say storage volume 208-1 is evaluated, the space utilized may be communicated to the subscriber and may be used for subsequent billing.

Although examples for the present disclosure have been described in language specific to structural features and/or methods, it should stood that the appended claims are not necessarily limited to the specific features or methods described. Rather, the specific features and methods are disclosed and explained as examples of the present disclosure.

I/We claim:

1. A method comprising:
determining a list of a plurality of storage volumes to be metered within a storage array coupled to a network computing environment;
identifying at least one storage usage category for at least one storage volume of the plurality of storage volumes, wherein the at least one storage usage category indicates how the at least one storage volume operates to store data in the network computing environment; and
determining a usage value for the at least one storage usage category for metering, wherein the usage value provides a measure of usage of the at least one storage volume.

2. The method as claimed in claim 1, wherein the storage usage category is indicative of the at least one storage volume comprising actual allocated storage blocks onto which data is written.

3. The method as claimed in claim 1, wherein the storage usage category is indicative of the at least one storage volume comprising one of a plurality of shared storage volumes.

4. The method as claimed in claim 3, wherein determining whether the at least one storage volume is the one of the plurality of shared storage volumes comprises:
obtaining a listing pertaining to the network computing environment, wherein the listing indicates port information of a plurality of servers and a plurality of storage volumes, wherein the plurality of servers are communicatively coupled to the plurality of storage volumes;
ascertaining whether port information of at least two servers of the plurality of servers is associated with the port information of the at least one storage volume; and
determining that the at least one storage volume is to be the one of the plurality of shared volumes based on the ascertaining.

5. The method as claimed in claim 4, wherein the listing further includes the list of the storage volumes within the storage array to be metered.

6. The method as claimed in claim 1, wherein the storage usage category is indicative of the at least one storage volume as being actively used for writing data.

7. The method as claimed in claim 6, wherein for determining whether the at least one storage volume is being actively used for writing data, the method further comprises:
for blocks present in the at least one storage volume, measuring data transferred during an input and output (I/O) operation;
further measuring input and output operations per second (IOPS) for the at least one storage volume; and
determining that the at least one storage volume is being actively used for writing data based on the measure of I/O operations and the measure of the IOPS.

8. The method as claimed in claim 1, wherein the storage usage category is indicative of the at least one storage volume being utilized for data replication.

9. A system comprising:
a usage metering engine to:
detect a storage array within a networked computing environment, wherein the storage array comprises a plurality of storage volumes;
determine at least one storage usage category for at least one storage volume to be metered from amongst the plurality of storage volumes, wherein the at least one storage usage category indicates how the at least one storage volume operates to store data in the network computing environment; and
obtain a usage value for the at least one storage volume, wherein the usage value provides a measure of storage usage of the at least one storage volume while operating as the at least one storage usage category.

10. The system as claimed in claim 9, wherein the at least one storage usage category is indicative of the at least one storage volume comprising one of actual blocks allocated for the storage volume, shared storage volume, volume of data being actively written to the storage volume, and replication data.

11. The system as claimed in claim 9, wherein the usage metering engine is to:
obtain network environment attributes for the networked computing environment;
identify a listing of the plurality of storage volumes included within the networked computing environment based on the network environment attributes; and
further identify the at least one storage volume for metering from the listing of the plurality of storage volumes, based on an input from a user.

12. The system as claimed in claim 11, wherein the usage metering engine is to determine the at least one storage usage category based on the network environment attributes.

13. The system as claimed in claim 11, wherein the network environment attributes include port information of a plurality of servers and the plurality of storage volumes, wherein the plurality of servers are communicatively coupled to the plurality of storage volumes.

14. A non-transitory computer-readable medium comprising instructions executable by a processing resource to:
determine at least one storage usage category for a storage volume identified for metering, wherein the at least one storage usage category indicates how the storage volume operates to store data over a networked computing environment, wherein the networked computing environment includes the storage volume; and
obtain a usage value for the storage volume of the at least one storage usage category, wherein the usage value provides a measure of usage of the storage volume.

15. The non-transitory computer-readable medium of claim 14, wherein the at least one storage usage category is identified based on attributes of the networked computing environment.
